(19) United States
(12) Patent Application Publication
(10) Pub. No.: US 2022/0045366 A1
(43) Pub. Date: Feb. 10, 2022

(54) METHOD FOR PRODUCTION OF LAMINATED SOLID ELECTROLYTE-BASED COMPONENTS AND ELECTROCHEMICAL CELLS USING SAME

(71) Applicant: SOLID POWER, INC., LOUISVILLE, CO (US)

(72) Inventors: HAITAO HUANG, BROOMFIELD, CO (US); BRANDON KELLY, LONGMONT, CO (US); JOSHUA BUETTNER-GARRETT, ARVADA, CO (US)

(21) Appl. No.: 17/393,978

(22) Filed: Aug. 4, 2021

Related U.S. Application Data
(60) Provisional application No. 63/061,151, filed on Aug. 4, 2020.

(51) Int. Cl. H01M 10/0585; H01M 10/052; H01M 10/0562; H01M 4/38; H01M 4/66; H01M 4/04; H01M 4/1395; H01M 4/134; H01M 50/449; H01M 50/446

(52) U.S. Cl. CPC H01M 10/0585; H01M 10/052; H01M 10/0562; H01M 4/382; H01M 4/661; H01M 4/0407; H01M 2004/027; H01M 4/1395; H01M 4/134; H01M 50/449; H01M 50/446; H01M 2300/0068; H01M 4/043

(57) ABSTRACT

A method for producing a solid electrolyte-based electrochemical cell by dry laminating the solid electrolyte layers to active material layers to form composite components, contacting composite components, and packaging the contacted composite components to form a solid electrolyte-based electrochemical cell.

### RELATED APPLICATIONS

This application claims priority to U.S. Provisional Application No. 63/061,151 filed on Aug. 4, 2020, the entire content of which is incorporated herein by reference.

### GOVERNMENT RIGHTS

This invention was made with government support under United States Department of Energy Award DE-AR0000399. The government has certain rights in the invention.

### FIELD

Various embodiments described herein relate to the field of solid-state primary and secondary electrochemical cells, electrodes, electrode materials, electrolyte, electrolyte compositions and corresponding methods of making and using same.

### BACKGROUND

With the ever-increasing adoption of mobile devices, electric automobiles, and the development of Internet-of-Things devices, the need for battery technologies with improved reliability, capacity (Ah), thermal characteristics, lifetime and recharge performance has never been greater. Although current lithium solid state battery technologies offer potential increases in safety, packaging efficiency, and enable new high-energy chemistries, further improvements are needed.

Solid state battery cells use solid electrolyte in place of traditional flammable electrolytic solution. Thus, the solid state battery cells are safer and can achieve theoretically high energy density. However, in the solid state battery cell, the movement of lithium ions or electrons can be more difficult as compared to that of an liquid electrolyte. This solid-to-solid contact generates a solid state interface, which can have increased resistance when compared to cells with liquid electrolyte. Therefore, battery characteristics, such as energy density, can be lower in solid state cells as compared to those using a liquid electrolyte.

For example, in the International Patent Publication No. WO2012/077197(A1), a solid state battery cell has been proposed where the positive electrode collector—positive electrode active material layer—solid electrolyte layer—negative electrode active material layer—negative electrode collector are combined by pressing them to form a stack, or pressing a positive electrode collector—positive electrode active material layer—solid electrolyte layer—negative electrode active material layer—negative electrode collector to form a stack.

However, when this stacking method is employed, significant problems can occur, such as shorting of the cell, increasing of cell resistance, and a lowering specific cell capacity may occur. This may be due to the solid state interface between the positive electrode layer and the solid electrolyte layer between the negative electrode layer and the solid electrolyte layer being of poor quality.

In contrast, the present disclosure provides a solid state battery cells with improved solid state interfaces between the positive electrode layer—solid electrolyte layer and between the negative electrode layer—solid electrolyte layer. Additionally, the present application discloses a cell architecture, which enhances cycle life, specific cell capacity, and lower cell resistance.

### SUMMARY

In an embodiment, a solid electrolyte-based electrochemical cell may be produced by dry laminating the solid electrolyte layers to active material layers to form composite components, contacting composite components, and optionally packaging the contacted composite components to form a solid electrolyte-based electrochemical cell.

In an embodiment, a method for producing a composite component for a solid electrolyte-based battery is disclosed, the method comprising applying a solid electrolyte material to at least one of an anode active material and a cathode active material and dry laminating the solid electrolyte material to the at least one of the anode active material and the cathode material to form a composite component.

In one embodiment of the method, the solid electrolyte material comprises sulfur and one of lithium compounds, sodium compounds, or magnesium compounds. In another embodiment of the method, the anode active material comprises at least one of lithium metal, sodium metal, and magnesium metal. In yet another embodiment, the method further comprises bonding the composite component to a current collector formed from at least one of aluminum, nickel, stainless steel and carbon fiber. In one embodiment of the method, dry laminating includes applying a force per unit area in the range of 2,000-100,000 PSI to the solid electrolyte material to promote adhesion to the anode active material and/or cathode active material. In another embodiment, the solid electrolyte material comprises a hardness greater than a hardness of the anode active material and/or cathode active material. In yet another embodiment, the method further includes heating the composite component to a temperature between 20 and 200° C. after dry laminating.

In one embodiment of the method, the solid electrolyte material comprises a thickness ranging from 0.5 to 150 microns. In another embodiment, the method further includes evaporating or sputtering the anode active material and/or cathode active material onto the solid electrolyte prior to laminating the solid electrolyte material to the anode active material and/or cathode active material. In yet another embodiment, the method further includes casting the solid electrolyte material from a slurry onto a carrier, then drying the solid electrolyte material prior to laminating the solid electrolyte material to the anode active material and/or cathode active material.

In an embodiment, a method for producing a solid electrolyte-based electrochemical cell is disclosed wherein the method comprises a) applying a solid electrolyte material to an anode active material; b) dry laminating the solid electrolyte material to the anode active material to form a composite anode component; c) applying a solid electrolyte material to a cathode active material containing layer; d) dry laminating the solid electrolyte material to the cathode active material containing layer to form a composite cathode component; and e) contacting the solid electrolyte material of the composite anode component with the solid electrolyte material of the composite cathode component to form a solid electrolyte-based electrochemical cell. Optionally, the composite can be packaged to form the solid electrolyte-based electrochemical cell. In one embodiment, the method further includes contacting by applying a force per unit area of <100 MPa to the solid electrolyte material to promote adhesion to the anode active material and/or cathode electrolyte material.

In another embodiment, the disclosure provides an electrochemical cell comprising a metal anode; a cathode, and; two separator layers in between the metal anode and the cathode wherein the separator layer, which is in contact with the anode, has a lower relative density than the separator layer, which is in contact with the cathode. In yet another embodiment of the electrochemical cell, each of the separator layers comprises a solid electrolyte. In another embodiment of the electrochemical cell, the solid electrolyte comprises sulfur. In another embodiment of the electrochemical cell, each of the separator layers further comprise a polymer binder.

In another embodiment of the electrochemical cell, the relative density of the separator layer in contact with the anode is 50-80% as compared to a maximum density of the solid state electrolyte. In another embodiment of the electrochemical cell, the relative density of the separator layer in contact with the cathode is 75%-99% as compared to a maximum density of the solid state electrolyte. In another embodiment of the electrochemical cell, the metal anode comprises lithium metal. In another embodiment of the electrochemical cell, the two separators are adhered to each other with a peel strength less than half of a peel strength of the separator to cathode layer peel strength.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic sectional view of an exemplary construction of a lithium solid-state electrochemical cell including a solid electrolyte, in accordance with an embodiment.

FIG. 2 is a flow chart of a process for producing a solid electrolyte electrochemical cell and components thereof, in accordance with an embodiment.

FIG. 3 is a schematic diagram of the flow chart of FIG. 2, in accordance with an embodiment.

FIG. 4A is a graph of the cell resistance in ohms for Example 1 and Comparative Example 1

FIG. 4B is a graph of the specific capacity in mAhg⁻¹ for Example 1 and Comparative Example 1

### DETAILED DESCRIPTION OF ILLUSTRATED EMBODIMENTS

In the following description, specific details are provided to impart a thorough understanding of the various embodiments of the disclosure. Upon having read and understood the specification, claims and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

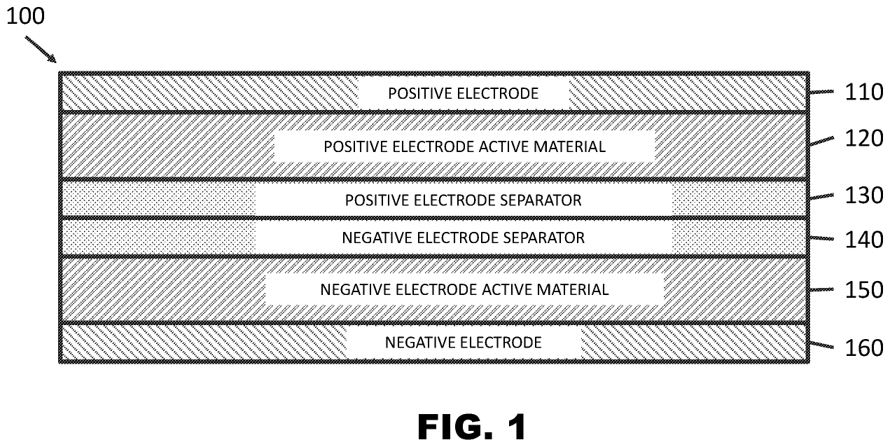

FIG. 1 is a schematic sectional view of an exemplary construction of a lithium solid-state electrochemical cell including a solid electrolyte assembly of the present invention. Lithium solid-state cell 100 includes positive electrode (current collector) 110, positive electrode active material (cathode) 120, positive electrode separator 130, negative electrode separator 140, negative electrode active material (anode) 150, and negative electrode (current collector) 160.

Positive electrode active material 120 may be positioned between positive electrode 110 and positive electrode separator 130. Negative electrode active material 150 may be positioned between negative electrode 160 and negative electrode separator 140. Positive electrode 110 electrically contacts positive electrode active material 120, and negative electrode 160 electrically contacts negative electrode active material 150.

In some embodiments, positive electrode 110 may be formed from materials including, but not limited to, aluminum, nickel, titanium, stainless steel, copper or carbon. In another embodiment, the positive electrode 110 may be formed from materials including, but not limited to, carbon coated aluminum, carbon coated nickel, carbon coated titanium, carbon coated stainless steel, and carbon coated copper. In yet another embodiment, the positive electrode 110 may be formed from materials including, but not limited to, ceramic coated aluminum, ceramic coated nickel, ceramic coated titanium, ceramic coated stainless steel, and ceramic coated copper where the ceramic coating may comprise alumina or zirconia.

Similarly, in some embodiments, negative electrode 160 may be formed from materials including, but not limited to, aluminum, nickel, titanium, stainless steel, copper or carbon. In another embodiment, the negative electrode 160 may be formed from materials including, but not limited to, carbon coated aluminum, carbon coated nickel, carbon coated titanium, carbon coated stainless steel, and carbon coated copper. In yet another embodiment, the negative electrode 160 may be formed from materials including, but not limited to, ceramic coated aluminum, ceramic coated nickel, ceramic coated titanium, ceramic coated stainless steel, and ceramic coated copper where the ceramic coating may comprise alumina or zirconia.

Positive electrode active material 120 may include one or more of lithiated nickel-manganese-cobalt oxide (NMC) materials such as NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂). In another embodiment, the positive electrode active material 120 may include one or more of a LiCoO₂ or lithium nickel cobalt aluminum oxides (LiNi_{0.8}Co_{0.15}Al_{0.05}O₂; NCA).

In yet another embodiment, the positive electrode active material 120 may be one or more of a different element-substituted Li—Mn spinels, for example, Li—Mn—Ni—O, Li—Mn—Al—O, Li—Mn—Mg—O, Li—Mn—Co—O, Li—Mn—Fe—O and Li—Mn—Zn—O may be used. In another embodiment, the positive electrode active material 120 may be one or more of a lithium metal phosphate such as LiFePO4, LiMnPO4, LiCoPO4 and LiNiPO4. In another embodiment, the positive electrode active material 120 may be one or more of a transition metal chalcogen such as V2O5, V6O13, MoO3, TiS2, and FeS2.

The positive electrode active material 120 may further include one or more of a binder, electrolyte and conductive additives. The binder may be one or more of a fluorine-containing binder such as polytetrafluoroethylene (PTFE) and polyvinylene difluoride (PVdF) and the like. In another embodiment, the binder may contain fluororesins such as vinylidene fluoride (VdF), hexafluoropropylene (HFP), tetrafluoroethylene (TFE), and derivatives thereof as structural units. Specific examples thereof include homopolymers such as poly (vinylene difluoride-hexafluoropropylene) copolymer (PVdF-HFP), polyhexafluoropropylene (PHFP) and binary copolymers such as copolymers of VdF and HFP.

In a further embodiment, the binder may be one or more selected from a thermoplastic-elastomer such as but not limited to styrene-butadiene rubber (SBR), styrene butadiene styrene copolymer (SBS), poly(styrene-isoprene-styrene) copolymer (SIS), poly(styrene-ethyl ene-butylene-styrene) copolymer (SEB S) polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may be one or more selected from an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In a further embodiment, the binder may be one or more selected from a polycondensation polymer such as but not limited to polyurea, polyamide paper, polyimide, polyester, and the like. In yet another embodiment, the binder may be one or more selected from a nitrile rubber such as but not limited to acrylonitrile-butadiene rubber (ABR), polystyrene nitrile-butadiene rubber (PS-NBR), and mixtures thereof.

The electrolyte included in the positive electrode active material 120 may be one or more of Li₂S—P₂S₅, Li₂S—P₂S₅—LiI, Li₂S—P₂S₅—LiBr, Li₂S—P₂S₅—LiCl, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZnSn (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). Specific exemplary electrolyte materials may be one or more of Li₃PS₄, Li₄P₂S₆, Li₆PS₇, Li₇P₃S₁₁, Li₁₀GeP₂S₁₂, Li₁₀SnP₂S₁₂. In another embodiment the electrolyte material may be one or more of Li₆PS₅Cl, Li₆PS₅Br, Li₆PS₅I or Li_{7-y}PS_{6-y}X_{y} where “X” represents at least one halogen elements and or pseudo-halogen and where 0<y≤2.0 and where the halogen may be one or more of F, Cl, Br, I, and a pseudo-halogen may be one or N, NH, NH₂, NO, NO₂, BF₄, BH₄, AlH₄, CN, and SCN. In yet another embodiment the electrolyte material may be one or more of a Li_{8-y-z}P₂S_{9-y-z}X_{y}W_{z} where “X” and “W” represents at least one halogen elements and or pseudo-halogen and where 0≤y≤1 and 0≤z≤1 and where a halogen may be one or more of F, Cl, Br, I, and a pseudo-halogen may be one or N, NH, NH₂, NO, NO₂, BF₄, BH₄, AlH₄, CN, and SCN. In yet a further embodiment, the electrolyte material may be one or more of a Li₄PS₄X, Li₄GeS₄X, Li₄SbS₄X, and Li₄SiS₄X where “X” represents at least one halogen elements and or pseudo-halogen and where a halogen may be one or more of F, Cl, Br, I, and a pseudo-halogen may be one or N, NH, NH₂, NO, NO₂, BF₄, BH₄, AlH₄, CN, and SCN

The conductive additive included in the positive electrode active material 120 may be one or more of a carbon material such as but are not limited to, vapor-grown carbon fiber (VGCF), carbon black, acetylene black, activated carbon, furnace black, carbon nanotube, Ketjen Black. In another embodiment, one or more of a graphite such as natural graphite or artificial graphite, and graphene may be used.

The thickness of the positive electrode active material 120 may be in the range of, for example, 1 μm to 1000 μm. In another embodiment, the thickness may be in the range of 5 μm to 750 μm. In yet another embodiment, the thickness may be in the range of 7.5 μm to 500 μm. In another embodiment, the thickness may be in the range of 10 μm to 250 μm. In yet another embodiment, the thickness may be in the range of 12 μm to 100 μm. In a further embodiment, the thickness may be in the range of 15 μm to 50 μ.

The negative electrode active material 150 may include but is not limited to, lithium metal and lithium alloys. In another embodiment, the negative electrode active material 150 may include alkali metals other than lithium such as sodium and potassium. In yet another embodiment, the negative electrode active material 150 may include alkaline-earth metals such as magnesium, calcium and other metals such as zinc.

The thickness of negative electrode active material 150 may be in the range of, for example, 0.1 μm to 1000 μm. In another embodiment, the thickness may be in the range of 0.5 μm to 750 μm. In yet another embodiment, the thickness may be in the range of 1 μm to 500 μm. In another embodiment, the thickness may be in the range of 5 μm to 250 μm. In yet another embodiment, the thickness may be in the range of 7.5 μm to 100 μm. In a further embodiment, the thickness may be in the range of 10 μm to 50 μm. In yet another embodiment, the thickness may be in the range of 15 μm to 40 μm.

Positive electrode separator 130 may include one or more of a solid electrolyte material, binder, sulfur or sulfur containing material, and non-reactive oxides.

The solid electrolyte included in the positive electrode separator 130 may be one or more of Li₂S—P₂S₅, Li₂S—P₂S₅—LiI, Li₂S—P₂S₅—LiBr, Li₂S—P₂S₅—LiCl, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂LiCl, Li₂S—S—SiS₂B₂S₃—LiI, Li₂S—S—SiS₂—P₂—S₅LiI, Li₂S—B₂S₃, Li₂S—P₂S₅—ZnSn (where m and n are positive numbers, and Z is Ge, Zn or Ga), Li₂—SGeS₂, Li₂S—S—SiS₂—Li₃PO₄, and Li₂S—S—SiS₂—LiₓMO_{y} (where x and y are positive numbers, and M is P, Si, Ge, B, Al, Ga or In. Specific exemplary electrolyte materials may be one or more of Li₃PS₄, Li₄P₂S₆, Li7PS₆, Li7P3S11, Li₁₀GeP₂S₁₂, Li₁₀SnP₂S₁₂. In another embodiment the electrolyte material may be one or more of a Li₆PS₅Cl, Li₆PS₅Br, Li₆PS₅I or Li_{7-y}PS_{6-y}X_{y} where “X” represents at least one halogen elements and or pseudo-halogen and where 0<y≤2.0 and where a halogen may be one or more of F, Cl, Br, I, and a pseudo-halogen may be one or N, NH, NH₂, NO, NO₂, BF₄, BH₄, AlH₄, CN, and SCN. In yet another embodiment the electrolyte material may be one or more of Li_{8-y-z}P₂S_{9-y-z}X_{y}W_{z} where “X” and “W” represents at least one halogen element and or pseudo-halogen and where 0≤y≤1 and 0≤z≤1 and where a halogen may be one or more of F, Cl, Br, I, and a pseudo-halogen may be one or N, NH, NH₂, NO, NO₂, BF₄, BH₄, AlH₄, CN, and SCN. In yet a further embodiment, the electrolyte material may be one or more of a Li₄PS₄X, Li₄GeS₄X, Li₄SbS₄X, and Li₄SiS₄X where “X” represents at least one halogen elements and or pseudo-halogen and where a halogen may be one or more of F, Cl, Br, I, and a pseudo-halogen may be one or N, NH, NH₂, NO, NO₂, BF₄, BH₄, AlH₄, CN, and SCN.

The binder included in the positive electrode separator 130 may be one of more of a fluorine-containing binder such as polytetrafluoroethylene (PTFE) and polyvinylene difluoride (PVdF) and the like. In another embodiment, the binder may contain fluororesins such as vinylidene fluoride (VdF), hexafluoropropylene (HFP), tetrafluoroethylene (TFE), and derivatives thereof as structural units. Specific examples thereof include homopolymers such as poly (vinylene difluoride-hexafluoropropylene) copolymer (PVdF-HFP), polyhexafluoropropylene (PHFP) and binary copolymers such as copolymers of VdF and HFP.

In a further embodiment, the binder may be selected from one or more of a thermoplastic-elastomer such as but not limited to styrene-butadiene rubber (SBR), styrene butadiene styrene copolymer (SBS), poly(styrene-isoprene-styrene) copolymer (SIS), poly(styrene-ethylene-butylene-styrene) copolymer (SEBS), polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may be selected from one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In a further embodiment, the binder may be selected from one or more of a polycondensation polymer such as but not limited to polyurea, polyamide paper, polyimide, polyester, and the like. In yet another embodiment, the binder may be selected from one or more of a nitrile rubber such as but not limited to acrylonitrile-butadiene rubber (ABR), polystyrene nitrile-butadiene rubber (PS-NBR), and mixtures thereof.

The sulfur or sulfur containing material included in the positive electrode separator 130 may be one of more of a lithium sulfide, sodium sulfides, potassium sulfide, magnesium sulfides, calcium sulfide, boron sulfide, iron sulfide or phosphorus sulfide. In another embodiment, the sulfur or sulfur containing material may be elemental sulfur.

The non-reactive sulfide material included in the positive electrode separator 130 may be one of more of a such as ZrO₂, and Al₂O₃.

A thickness of positive electrode separator 130 is in the range of 0.5 to 1000 μm. In another embodiment the thickness may be in the range of 1 μm to 500 μm. In another embodiment, the thickness may be in the range of 5 μm to 250 μm. In yet another embodiment, the thickness may be in the range of 7.5 μm to 100 μm. In a further embodiment, the thickness may be in the range of 10 μm to 50 μm. In yet another embodiment, the thickness may be in the range of 15 μm to 40 μ.

The negative electrode separator 140 may additionally or alternatively include binders, sulfur, and non-reactive oxides.

The solid electrolyte included in the negative electrode separator 140 may be one or more of Li₂S—P₂S₅, Li₂S—P₂S₅—LiI, Li₂S—P₂S₅—LiBr, Li₂S—P₂S₅—LiCl, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZnSn (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In. Specific exemplary electrolyte materials may be one or more of Li₃PS₄, Li₄P₂S₆, Li₇PS₆, Li₇P₃S₁₁, Li₁₀GeP₂S₁₂, Li₁₀SnP₂S₁₂. In another embodiment the electrolyte material may be one or more of a Li₆PS₅Cl, Li₆PS₅Br, Li₆PS₅I or Li_{7-y}PS_{6-y}X_{y} where “X” represents at least one halogen elements and or pseudo-halogen and where 0<y≤2.0 and where a halogen may be one or more of F, Cl, Br, I, and a pseudo-halogen may be one or N, NH, NH₂, NO, NO₂, BF₄, BH₄, AlH₄, CN, and SCN. In yet another embodiment the electrolyte material may be one or more of a Li_{8-y-z}P₂S_{9-y-z}X_{y}W_{z} where “X” and “W” represents at least one halogen elements and or pseudo-halogen and where 0≤y≤1 and 0≤z≤1 and where a halogen may be one or more of F, Cl, Br, I, and a pseudo-halogen may be one or N, NH, NH₂, NO, NO₂, BF₄, BH₄, AlH₄, CN, and SCN. In yet a further embodiment, the electrolyte material may be one or more of a Li₄PS₄X, Li₄GeS₄X, Li₄SbS₄X, and Li₄SiS₄X where “X” represents at least one halogen elements and or pseudo-halogen and where a halogen may be one or more of F, Cl, Br, I, and a pseudo-halogen may be one or N, NH, NH₂, NO, NO₂, BF₄, BH₄, AlH₄, CN, and SCN.

The binder included in the negative electrode separator 140 may be one of more of a fluorine-containing binder such as polytetrafluoroethylene (PTFE) and polyvinylene difluoride (PVdF) and the like. In another embodiment, the binder may contain one or more of a fluororesins such as vinylidene fluoride (VdF), hexafluoropropylene (HFP), tetrafluoroethylene (TFE), and derivatives thereof as structural units. Specific examples thereof include homopolymers such as poly (vinylene difluoride-hexafluoropropylene) copolymer (PVdF-HFP), polyhexafluoropropylene (PHFP) and binary copolymers such as copolymers of VdF and HFP.

In a further embodiment, the binder may be selected from one or more of a thermoplastic-elastomer such as but not limited to styrene-butadiene rubber (SBR), styrene butadiene styrene copolymer (SBS), poly(styrene-isoprene-styrene) copolymer (SIS), poly(styrene-ethylene-butylene-styrene) copolymer (SEBS), polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may be selected from one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In a further embodiment, the binder may be selected from one or more of a polycondensation polymer such as but not limited to polyurea, polyamide paper, polyimide, polyester, and the like. In yet another embodiment, the binder may be selected from one or more of a nitrile rubber such as but not limited to acrylonitrile-butadiene rubber (ABR), polystyrene nitrile-butadiene rubber (PS-NBR), and mixtures thereof.

The sulfur or sulfur containing material included in the negative electrode separator 140 may be one of more of a lithium sulfide, sodium sulfides, potassium sulfide, magnesium sulfides, calcium sulfide, boron sulfide, iron sulfide or phosphorus sulfide. In another embodiment, the sulfur or sulfur containing material may be elemental sulfur.

The non-reactive sulfide material included in the negative electrode separator 140 may be one of more of a such as ZrO₂, and Al₂O₃.

A thickness of the negative electrode separator 140 is in the range of 0.5 μm to 1000 μm. In another embodiment the thickness may be in the range of 1 μm to 500 μm. In another embodiment, the thickness may be in the range of 5 μm to 250 μm. In yet another embodiment, the thickness may be in the range of 7.5 μm to 100 μm. In a further embodiment, the thickness may be in the range of 10 μm to 50 μm. In yet another embodiment, the thickness may be in the range of 15 μm to 40 μm.

Positive electrode separator 130 and negative electrode separator 140 may be the same or different materials and/or compositions as long as appropriate contact is maintained between the solid electrolytes and other materials included within the separator and the anode and cathode materials and active materials. In general, the separator must be able to transport ions without substantially reacting with either the anode or the cathode. Using the same separator and the same solid electrolyte in each of the positive electrode separator 130 and negative electrode separator 140 allows for easier processing, lower production time, and decreased cost.

Although indicated in FIG. 1 as a lamellar structure, it is well known that other shapes and configurations of solid-state electrochemical cells are possible. Most generally, a lithium solid-state battery may be produced by providing a positive electrode active material layer, a solid electrolyte layer, and a negative electrode active material layer sequentially layered and pressed between electrodes and provided with a housing.

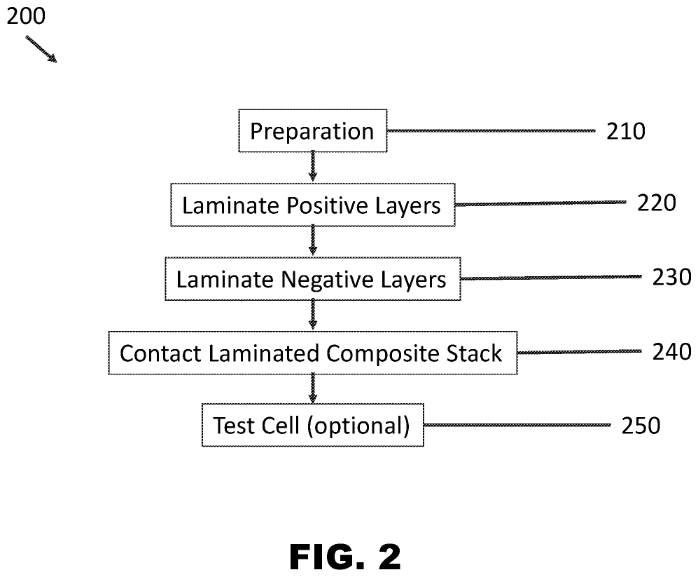

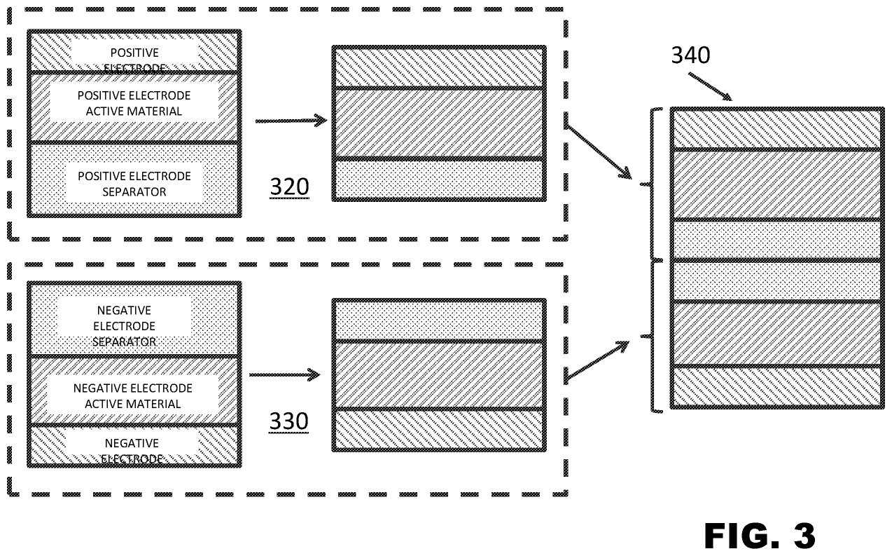

FIG. 2 is a flow chart of a process for producing a solid electrolyte electrochemical cell and components thereof and will be described in association with FIG. 3 which is a schematic diagram of certain steps of the flow chart of FIG. 2. Process 200 begins with preparation step 210 wherein any preparation action such as precursor synthesis, purification, and equipment preparation may take place. Preparation may include wet slurry casting of a prepared separator including a solid electrolyte onto a substrate carrier such as aluminum foil or plastic film and drying the cast solid electrolyte prior to lamination.

After any initial preparation, process 200 advances to step 220 wherein a positive electrode, a positive electrode active material and a positive electrode separator may be laminated to form a composite positive electrode (cathode) stack. This step is represented by element 320 of FIG. 3. For example, a cathode stack may be fabricated by laminating a separator including a solid electrolyte to an NMC composite cathode and forming interfacial contact between the NMC composite cathode and the separator including the solid electrolyte that provides optimal mechanical contact.

Next in step 230, a negative electrode, a negative electrode active material and a negative electrode separator may be laminated to form a composite negative electrode (anode) stack. This step is represented by element 330 of FIG. 3. For example, a lithium-based anode stack may be fabricated by laminating a separator including solid electrolyte to lithium foil and forming interfacial contact between the lithium foil and the solid electrolyte that ensures lithium plating/stripping efficiency. Alternatively, in place of lithium foil, lithium may be deposited by, for example, vapor deposition or sputtering onto a stainless steel, copper or carbon fiber foil. The alternative stack would then be foil\lithium\separator where the separator including the solid electrolyte is laminated to the deposited lithium metal.

Steps 220 and 230 may be performed in any order. Alternatively, to the above-mentioned lamination of each of the sets of three layers, lamination may be divided into two substeps wherein appropriate adjacent pairs of layers may first be laminate followed by the lamination of the remaining single layer to the two-layer composite. For example, a positive electrode may be laminated to a positive electrode active material to form an intermediate composite stack to which a positive electrode separator is then laminated. The lamination during steps 220 and 230 includes densification where the separator including a solid electrolyte is laminated to its corresponding electrode active material and where the separator including a solid electrolyte laminated to the negative electrode active material is less dense than the separator including a solid electrolyte laminated to the positive electrode active material. Prior to lamination, the positive and negative separator layers may be very similar in density before they come in contact with their respective positive and negative active material layers. Once each composite stack is laminated, the different lamination conditions result in the separator layers having different densities. For example, the relative density, compared to the maximum density of the solid state electrolyte, of the separator layer in contact with the anode may be 50-80% where the maximum density may be in the range of 1.0 gcm⁻³ to 4.0 gcm⁻³. In some embodiments, the maximum density of the separator layer in contact with the anode be in the range of 1.10 gcm⁻³ to 3.75 gcm⁻³. In a further embodiment the maximum density may be 1.20 gcm⁻³ to 3.50 gcm⁻³. In yet another embodiment the maximum density may be 1.30 gcm⁻³ to 3.25 gcm⁻³. In a further embodiment the maximum density may be 1.40 gcm⁻³ to 3.00 gcm⁻³. In yet a further embodiment the maximum density may be 1.50 gcm⁻³ to 2.75 gcm⁻³. The and the relative density, compared to the maximum density of the solid state electrolyte, of the separator layer in contact with the cathode may be 75%-99% where the maximum density may be in the range of 1.00 gcm⁻³ to 4.00 gcm⁻³. In some embodiments, the maximum density of the separator layer in contact with the anode be in the range of 1.10 gcm⁻³ to 3.75 gcm⁻³. In a further embodiment the maximum density may be 1.20 gcm⁻³ to 3.50 gcm⁻³. In yet another embodiment the maximum density may be 1.30 gcm⁻³ to 3.25 gcm⁻³. In a further embodiment the maximum density may be 1.4 gcm⁻³ to 3.00 gcm⁻³. In yet a further embodiment the maximum density may be 1.50 gcm⁻³ to 2.75 gcm⁻³. During lamination of the negative anode layers, a pressure of approximately 10,000 psi may be applied to the separator including a solid electrolyte and the corresponding active material. In some embodiments a pressure of 10,000 psi to 1,000 psi may be applied. In a further embodiment, a pressure of 8,000 psi to 2,000 may be applied. In a further embodiment, a pressure of 7,000 psi to 3,000 psi may be applied. The pressure applied during the lamination of the negative electrode layers may be expressed as linear foot lbs. In some embodiments the pressure that is applied may be in the range of 10,000 linear foot lbs to 1,000 linear foot lbs. In another embodiment the pressure that is applied may be in the range of 8,000 linear foot lbs to 2,000 linear foot lbs. In a further embodiment the pressure that is applied may be in the range of 7,000 linear foot lbs to 3,000 linear foot lbs. During lamination of the positive cathode layers, a pressure of approximately 50,000 psi or higher may be used. In some embodiments, a pressure of 50,000 psi to 300,000 psi may be used. In another embodiment a pressure of 50,000 psi to 200,000 psi may be used. In a further embodiment a pressure of 50,000 psi to 100,000 psi may be used. The pressure applied during the lamination of the positive electrode layers may be expressed as linear foot lbs. In some embodiments the pressure that is applied may be in the range of 300,000 linear foot lbs to 50,000 linear foot lbs. In another embodiment the pressure that is applied may be in the range of 200,00 linear foot lbs to 50,000 linear foot lbs. In a further embodiment the pressure that is applied may be in the range of 100,000 linear foot lbs to 100,000 linear foot lbs. Higher pressures typically also result in a decrease in cell impedance. With the inclusion of different binders, solid electrolytes and other elements within the separator, lamination may require lower pressures in the range of 2,000-10,000 psi. Harder materials or less malleable active materials may require higher pressures up to 100,000 psi. The positive electrode separator layer and the negative electrode separator layer may have the same or different thicknesses. Additionally, differences in porosity may exist before or after the lamination and densification of the positive electrode separator layer and the negative electrode separator layer. Lamination may occur subsequent to or simultaneous with heating to a temperature in the range of 20-200 ° C. In some embodiments the temperature range may be in the range of 50-200° C. In a further embodiment the temperature may be in the range of 70-180° C. In yet another embodiment the temperature may be in the range of 85-150° C.

In step 240, the negative and positive laminated composite stacks are contacted, by bringing the negative and positive electrode separators including solid electrolytes into appropriate proximity, to form an electrochemical cell. The negative and positive electrode separators including solid electrolytes are not laminated as in steps 220 and 230 but may use an applied pressure less than 100 MPa to promote the interfacial contact. In some embodiments the applied pressure may be less than 75 MPa. In another embodiment the pressure may be less than 50 MPa. In a further embodiment the applied pressure may be less than 25 MPa. In yet another embodiment the applied pressure may be less than 10 MPa. In yet a further embodiment, the applied pressure may be less than 5 MPa. For example, the two separators may be adhered with a peel strength less than half of the peel strength of the separator to cathode layer. This step is represented by element 340 of FIG. 3. Bringing the negative and positive electrode separators including solid electrolytes into contact without laminating allows for performance benefits, such as, superior dendrite prevention enabling longer cycle life and faster charge capabilities.

Alternative structures such as changing from the above-described dual solid electrolyte based separator construction (cathode/separator-separator/anode) to a single solid electrolyte based separator construction (cathode/separator/anode) or to a fully laminated dual solid electrolyte based separator construction, may have a reduction in performance. Example cell construction may include an all-sold-state lithium electrochemical cell based on lithium/separator and cathode/separator lamination, in which lithium/separator anodes with a cathode or cathode/separator are stacked upon each other and wrapped in aluminum laminated film (aluminum foil plus carbon fiber sheet as current collector) to form a prismatic cell. A bipolar stacked pouch cell may also be formed, in which the current collector may be stainless steel or nickel.

In optional step 250, the constructed cell may be tested. Testing may include drying under an inert atmosphere such as argon or nitrogen or under vacuum for a predetermined period of time and temperature. Following drying, heat treatment may be applied. The temperature of heat treatment is not particularly limited, and may be in the range of 20-150° C. Heat treatment may be used to alter the interfacial characteristics of any of the laminated or contacted material layers.

### EXAMPLES

### Example 1

### Preparation of the Positive Electrode Layer

Powders were weighted out in a glovebox in a weight ratio of positive electrode active material NMC711:Li2S—P2S5-LiI solid electrolyte:VGCF (with a purity of 99.0%, Sigma-Aldrich Co. LLC.):Carbon Black (with a purity of 98.0%, Sigma-Aldrich Co. LLC.):SEBS polymer (with a purity of 98.0%, Sigma-Aldrich Co. LLC.): PVDF polymer (with a purity of 98.0%, Sigma-Aldrich Co. LLC.)=66:27:0.35:3.15:2:1.5. This powder mixture was then added to a solution of xylenes where the components were mixed for 2 minutes at 2000 rpm using a high-sheer mixer. Once completed, this mixture was then coated on carbon coated aluminum foil by a blade method using an applicator. After that, it was dried under vacuum at 80° C. for over 5 hours forming the positive electrode layer.

### Preparation of the Solid State Electrolyte Layer

Powders were weighted out in a glovebox in a weight ratio of solid electrolyte material Li2S—P2S5-LiI:SEBS polymer (with a purity of 98.0%, Sigma-Aldrich Co. LLC.): PVDF polymer (with a purity of 98.0%, Sigma-Aldrich Co. LLC.)=95.5:2:2.5 was mixed with a solution of xylenes for 10 minutes at 2000 rpm using a high-sheer mixer. Once completed, this mixture was then coated on aluminum foil by a blade method using an applicator. After that, it was dried under vacuum at 80° C. for 5 hours forming the solid state electrolyte layer.

### Production of the Solid State Battery Cell

In an inert gas environment, the positive electrode layer and a second solid state electrolyte layer were punched out in a size of 2 cm², arranged in such a manner as to have the positive electrode layer and solid state electrolyte layer overlap and have contact with each other. These two layers were then pressed at a pressure of 3500 psi. Then, the base material in contact with the second solid electrolyte layer was removed, whereby the second solid electrolyte layer was arranged (transferred) on a surface of the positive electrode layer forming a positive electrodesolid state electrolyte bilayer (320 of FIG. 3). Next, the lithium metal negative electrode layer and a first solid state electrolyte layer were punched out in a size of 2 cm2, and arranged in such a manner as to have the negative electrode layer and solid state electrolyte layer overlap and have contact with each other. These two layers were then pressed at a pressure of 3500 psi. Then, the base material in contact with the first solid state electrolyte layer was removed, whereby the first solid electrolyte layer was arranged (transferred) on a surface of the lithium metal negative electrode layer forming a negative electrode—solid state electrolyte bilayer (330 of FIG. 3). Now, the positive electrode—solid state electrolyte bilayer and negative electrode—solid state electrolyte bilayer are arranged in such a manner as to have the two bilayers overlap and have contact with each other where contact is made between the solid electrolyte layer of the negative electrode containing bilayer and the solid electrolyte layer of the positive electrode containing bilayer whereby a solid state battery cell (the solid state battery cell of Example 1) as seen in 340 of FIG. 3 is formed.

### Comparative Example 1

### Preparation of the Positive Electrode Layer

The preparation of the positive electrode layer remains the same as in Example 1.

### Preparation of the Solid State Electrolyte Layer

The preparation of the solid state electrolyte layer remains the same as in Example 1

### Production of the Solid State Battery Cell

In an inert gas environment, the lithium metal negative electrode layer and a second solid state electrolyte layer were punched out in a size of 2 cm2, arranged in such a manner as to have the negative electrode layer and solid state electrolyte layer overlap and have contact with each other. These two layers were then pressed at a pressure of 3500 psi. Then, the base material in contact with the second solid electrolyte layer was removed, whereby the second solid electrolyte layer was arranged (transferred) on a surface of the negative electrode layer forming a positive electrode—solid state electrolyte bilayer (330 of FIG. 3). Next, the positive electrode layer was punched out in a size of 2 cm2. This layer was then pressed at a pressure of 3500 psi forming a positive electrode layer. Now, the positive electrode layer and negative electrode—solid state electrolyte bilayer are arranged in such a manner as to have the positive electrode layer overlap and have contact with the solid electrolyte layer of the negative electrode containing whereby a solid state battery cell (the solid state battery cell of Comparative Example 1) is formed.

### Performance Evaluation

The solid state battery cells of Example 1 and Comparative Example 1 were placed in a device such that an electrical connection could be made and a stack pressure or confinement pressure of 55 foot lbs could be applied and thereafter the performance of the solid state battery cells was evaluated. Solid state battery cell of Example 1 and solid state battery cell of Comparative Example 1 was subject to 78 cycles of charging and discharging at 0.1 C rate and constant current and voltage within a voltage of 4.0V to 2.5V. The performance evaluation of the solid state battery cell of Example 1 and solid state battery cell of Comparative 1 was carried out by examining the retention of specific capacity and change in cell resistance over the course of the 78 charge and discharge cycles.

### Results

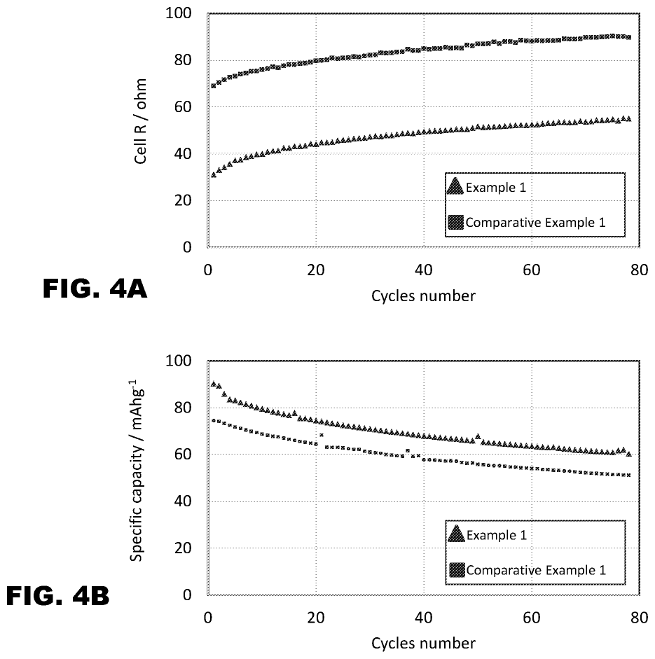

The performance evaluation results are shown in FIG. 4(A and B). FIG. 4A shows that though the cell resistance for both Example 1 and Comparative Example 1 solid state battery cells increased over the course of the 78 cycles, the solid state battery cell of Example 1 remained lower. This difference was so great that the cell resistance of solid state battery cell of Example 1 measured at 78 cycles was lower than that of solid state battery cell of Comparative Example 1 when measured at cycle 1. FIG. 4B shows that though the specific capacity for both Example 1 and Comparative Example 1 solid state battery cells fell over the course of the 78 cycles, the solid state battery cell of Example 1 start with and maintained a higher specific capacity when compared to the solid state battery cell of Comparative Example 1. Both of these differences can be contributed to the fact that the solid state battery cell of Example 1 has a superior solid state interface between the positive electrode layer and the solid state electrolyte layer.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed:

1. A method for producing a composite component for a solid electrolyte-based battery comprising:
applying a solid electrolyte material to at least one of an anode active material and a cathode active material; and
dry laminating the solid electrolyte material to the at least one of the anode active material and the cathode material to form a composite component.

2. The method as recited in claim 1 wherein the solid electrolyte material comprises sulfur and one of lithium compounds, sodium compounds, or magnesium compounds.

3. The method as recited in claim 1 wherein the anode active material comprises at least one of lithium metal, sodium metal, and magnesium metal.

4. The method as recited in claim 1 further comprising bonding the composite component to a current collector formed from at least one of aluminum, nickel, stainless steel and carbon fiber.

5. The method as recited in claim 1 wherein dry laminating includes applying a force per unit area in the range of 2,000-100,000 PSI to the solid electrolyte material to promote adhesion to the anode active material and/or cathode active material.

6. The method as recited in claim 1 wherein the solid electrolyte material comprises a hardness greater than a hardness of the anode active material and/or cathode active material.

7. The method as recited in claim 1 further including heating the composite component to a temperature between 20 and 200° C. after dry laminating.

8. The method as recited in claim 1 wherein the solid electrolyte material comprises a thickness ranging from 0.5 to 150 microns.

9. The method as recited in claim 1 further including evaporating or sputtering the anode active material and/or cathode active material onto the solid electrolyte prior to laminating the solid electrolyte material to the anode active material and/or cathode active material.

10. The method as recited in claim 1 further including casting the solid electrolyte material from a slurry onto a carrier, then drying the solid electrolyte material prior to laminating the solid electrolyte material to the anode active material and/or cathode active material.

11. A method for producing a solid electrolyte-based electrochemical cell comprising:
a) applying a solid electrolyte material to an anode active material;
b) dry laminating the solid electrolyte material to the anode active material to form a composite anode component;
c) applying a solid electrolyte material to a cathode active material containing layer;
d) dry laminating the solid electrolyte material to the cathode active material containing layer to form a composite cathode component; and
e) contacting the solid electrolyte material of the composite anode component with the solid electrolyte material of the composite cathode component to form a solid electrolyte-based electrochemical cell.

12. The method as recited in claim 11 wherein contacting further includes applying a force per unit area of <100 MPa to the solid electrolyte material to promote adhesion to the anode active material and/or cathode electrolyte material.

13. An electrochemical cell comprising:
a metal anode;
a cathode, and;
two separator layers in between the metal anode and the cathode
wherein the separator layer, which is in contact with the anode, has a lower relative density than the separator layer, which is in contact with the cathode.

14. The electrochemical cell of claim 13 wherein each of the separator layers comprise a solid electrolyte.

15. The electrochemical cell of claim 14 wherein the solid electrolyte comprises sulfur.

16. The electrochemical cell of claim 14 wherein each of the separator layers further comprise a polymer binder.

17. The electrochemical cell of claim 14 wherein a relative density of the separator layer in contact with the anode is 50-80% as compared to a maximum density of the solid state electrolyte.

18. The electrochemical cell of claim 14 wherein a relative density of the separator layer in contact with the cathode is 75%-99% as compared to a maximum density of the solid state electrolyte.

19. The electrochemical cell of claim 13 wherein the metal anode comprises lithium metal.

20. The electrochemical cell of claim 13 where the two separators are adhered to each other with a peel strength less than half of a peel strength of the separator to cathode layer peel strength.
